(19) United States
(12) Patent Application Publication
(10) Pub. No.: US 2015/0101469 A1
(43) Pub. Date: Apr. 16, 2015

(54) CLIPPING TOOL

(71) Applicant: ROLLS-ROYCE PLC, London (GB)

(72) Inventor: John McBAIN, Glasgow (GB)

(21) Appl. No.: 14/492,778

(22) Filed: Sep. 22, 2014

(30) Foreign Application Priority Data
Oct. 15, 2013 (GB) 1318236.5

(51) Int. Cl. B26D 7/18; B21J 1/00

(52) U.S. Cl. CPC B26D 7/18; B21J 1/00; B26D 2007/0018
USPC 83/112

(57) ABSTRACT

A clipping tool for clipping flash from a forged component is provided. The clipping tool includes: a riser having a support surface for supporting the component; a punch for gripping the component on the support surface such that the flash projects laterally from the riser and the punch; and a tool body having an aperture through which the riser and the punch are translatable to shear the projecting flash from the gripped component, the sheared flash being pushed by the tool body over an outer surface of the punch. The clipping tool further includes: a controllably movable receptacle which, when the punch is withdrawn from the aperture, is interposed between the punch and the riser; and a stripper element which is actuatable to strip the sheared flash from the outer surface of the punch, the stripped flash being received by the interposed receptacle, which is then moved to dispose of the stripped flash.

### FIELD OF THE INVENTION

The present invention relates to a clipping tool for clipping a component and particularly but not exclusively to a clipping tool for clipping a forged component such as a gas turbine aerofoil body.

### BACKGROUND OF THE INVENTION

Metal components are forged by applying compressive loads to form the metal into the desired shape. This is conventionally achieved by placing the metal between two dies which are forced together such that the metal forms into the interior profile of the dies. In doing so, metal is often forced through the interface of the two dies, the parting line, creating a burr around the component, known as flash. The flash can be removed by a subsequent clipping or trimming process.

Conventionally, clipping processes use a clipping die to hold a component as it is forced through clipping steels having an aperture sized to the desired final shape of the component. The component is placed on top of the die so that the flash extends outside. The component is then forced through the opening in the clipping steels by a punch causing the flash extending outside the dies to be sheared from the component.

A clipping process is shown in FIGS. 1 and 2 for clipping components having an aerofoil surface, such as a compressor stator vanes or blades. The process uses a clipping die 2, as shown in FIG. 1, having a riser 4 and a base 6. The riser 4 comprises a support surface 8 for supporting the component above the base 6. The support surface 8 comprises a cutting edge 10 around the edge of the support surface 8.

The riser 4 further comprises referencing members 12 disposed at opposing ends of the riser 4 adjacent to the support surface 8. A recess 14 is provided for receiving a root portion of the component.

As shown in FIG. 2, the riser 4 is located accurately within a tool body formed by a pair of clipping steels 16 (only one shown for diagrammatical purposes), one at each side of the riser 4. The riser 4 and base 6 are mounted on a hydraulic cylinder which provides a reaction force to counteract the force of a punch (not shown). The punch is driven down under hydraulic power to clamp the component on the riser 4 and drive the punch, component and riser 4 down through the clipping steels 16. As the punch, component and riser 4 pass through the clipping steels 16, flash is sheared off between the edges of the punch and the clipping steels 16.

In use, the component is placed on the riser 4, such that the root portion is received within the recess 14. The component is provided with two pips which act as reference portions that engage with the referencing members 12. The reference portions may be forged into the component for this purpose, or they may be an artefact of the forging process resulting from a gutter provided in the dies to allow overflow of excess metal.

US 2012/0151755 describes a development of the clipping die shown in FIGS. 1 and 2 having referencing members which are mounted on resilient elements. This allows the referencing members to move in the direction of action of the punch such that the component is fully supported by the support surface.

### SUMMARY OF THE INVENTION

A problem with conventional clipping tools is that the clipped flash tends to be retained on an outer surface of the punch due to hoop stresses within the sheared material. Repeated clipping operations can lead to a build-up of clipped flash on the punch which can interfere with the proper operation of the tool. However, if the flash is simply pushed off the punch after each clipping operation, it can accumulate in the vicinity of the riser, causing mis-loads and damage to tooling.

Accordingly, the present invention provides a clipping tool for clipping flash from a component, the clipping tool including:
a riser having a support surface for supporting the component;
a punch for gripping the component on the support surface such that the flash projects laterally from the riser and the punch; and
a tool body having an aperture through which the riser and the punch are translatable to shear the projecting flash from the gripped component, the sheared flash being pushed by the tool body over an outer surface of the punch;
wherein the clipping tool further includes:
a controllably movable receptacle which, when the punch is withdrawn from the aperture, is interposed between the punch and the riser; and
a stripper element which is actuated to strip the sheared flash from the outer surface of the punch, the stripped flash being received by the interposed receptacle (for example the stripped flash may simply fall by gravity onto the receptacle), which is then moved to dispose of the stripped flash.

Advantageously, the stripper element allows the removal of sheared flash from the punch to be automated, thus increasing the efficiency and speed of the clipping operation. The receptacle also facilitates automation of the process. However, in addition, by being interposed between the punch and the riser, it helps to prevent stripped flash material falling on the riser, thereby reducing mis-loads and damage to tooling.

Optional features of the invention will now be set out. These are applicable singly or in any combination.

The clipping tool may further include a control system which controls and coordinates movement of the receptacle and actuation of the stripper element. Indeed, more generally, the control system may control other actions of the tool, such as the clipping process itself. The control system can thus integrate the actions of the receptacle and stripper element with those other actions.

The stripper element may be hydraulically actuated.

The stripper element may provide a further aperture through which the punch slides to strip the sheared flash from the outer surface of the punch.

The clipping tool may further include a robotic arm with a gripper which collects and removes the clipped component from the punch. Conveniently, the receptacle can then be mounted on the robotic arm, the receptacle being interposed between the punch and the riser when the gripper collects the clipped component from the punch.

The riser may be hydraulically cushioned.

The component may be a forged component.

The component may be a gas turbine engine component, e.g. an aerofoil body such as a stator vane or rotor blade.

### BRIEF DESCRIPTION OF THE DRAWINGS

Embodiments of the invention will now be described by way of example with reference to the accompanying drawings in which:

FIG. 1 is a perspective view of a conventional clipping die;

FIG. 2 is a perspective view of the clipping die of FIG. 1 and an associated clipping steel; and

FIGS. 3 to 18 show a sequence of perspective and side views of a clipping tool performing a clipping operation.

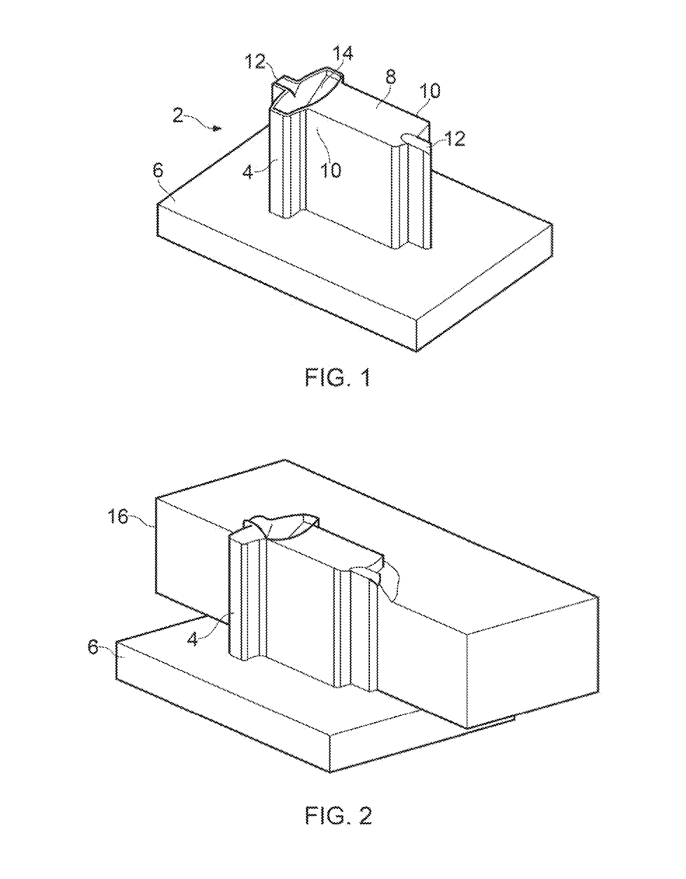

### DETAILED DESCRIPTION AND FURTHER OPTIONAL FEATURES OF THE INVENTION

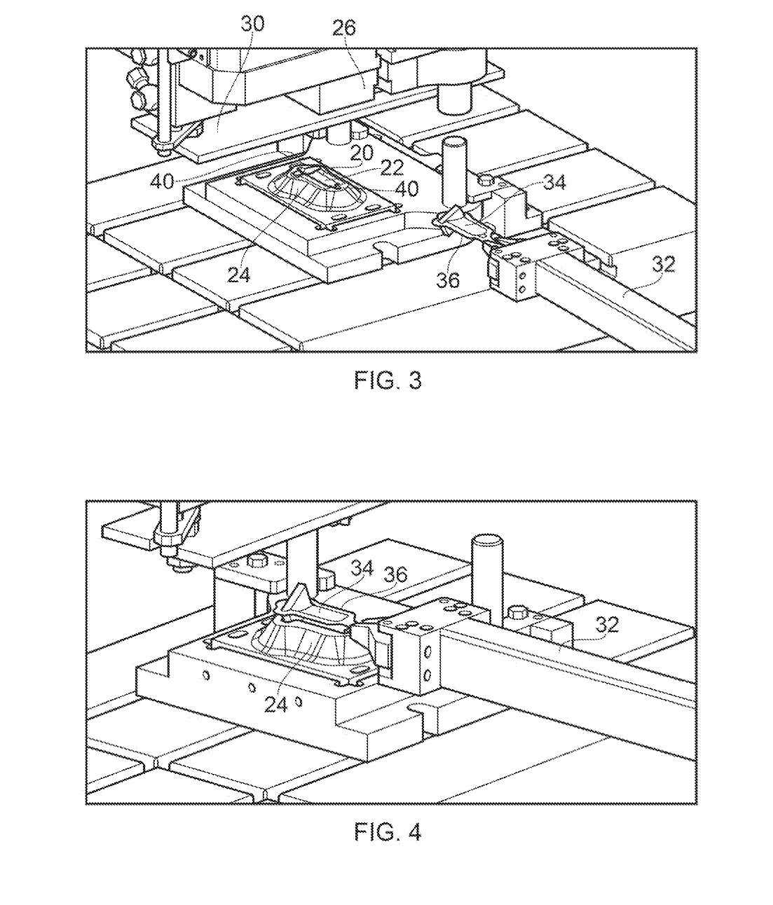

FIGS. 3 to 18 show a clipping operation using a clipping tool of the present invention.

As shown in the perspective view of FIG. 3, the tool includes a hydraulically cushioned riser 20 having a support surface 22 for an aerofoil blade. A tool body 24 surrounds the riser and provides a clipping aperture through which the riser can descend. An upper ram 26 carries a punch 28 (shown in FIG. 6) and a hydraulically operated stripper plate 30 containing a further aperture through which the punch extends.

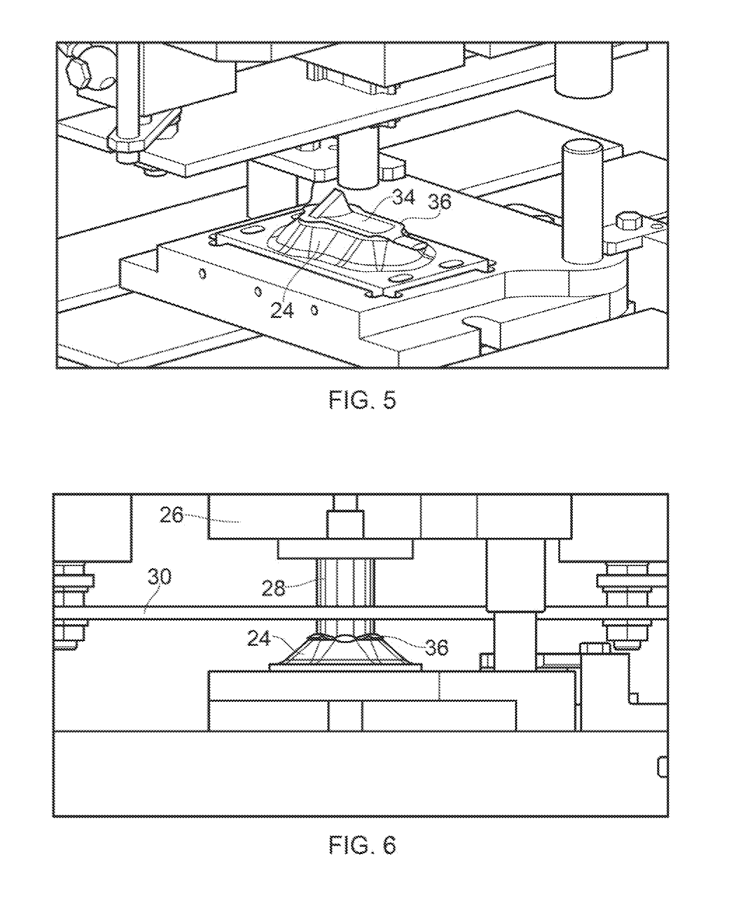

A first robot arm 32 carries a forged aerofoil blade 34 to the riser 20, the blade having a border of surrounding flash 36. The robot arm deposits the blade onto the support surface 22 of the riser 20 (FIG. 4 perspective view), and then withdraws, leaving the blade in position to be clipped (FIG. 5 perspective view). The blade has reference portions 38 at each end which are received in corresponding reference members 40 of the riser to properly locate the blade on the riser.

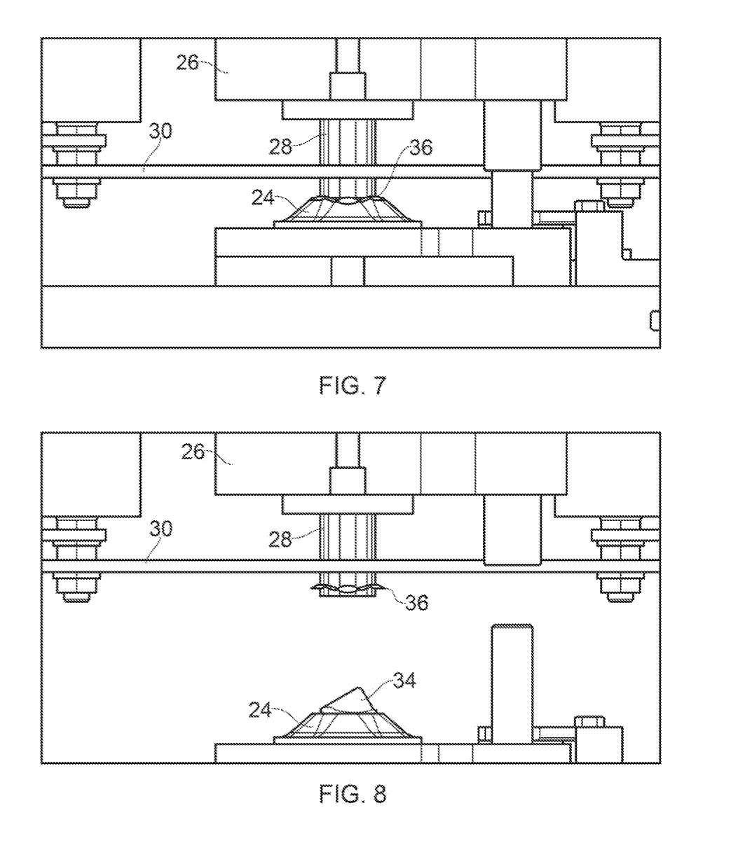

The withdrawing first robot arm signals the upper ram 26 to descend, commencing the clipping stroke (FIG. 6 side view). Firstly, the blade 34 is gripped between the riser 20 and the punch 28. The riser and the punch then descend through the clipping aperture of the tool body 24 to shear the flash 36 from the blade (FIG. 7 side view). The sheared flash is pushed by the upper surface of the tool body over the outer surface of the punch.

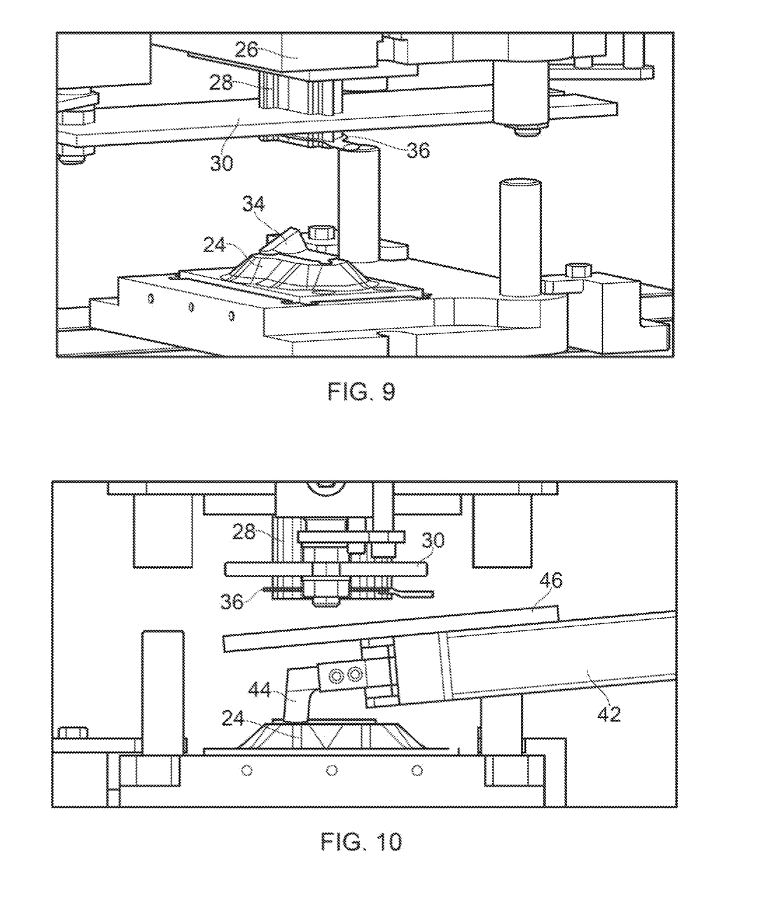

The upper ram 26 returns to the top of its stroke (FIGS. 8 and 9 side views), with the sheared flash retained on the outer surface of the punch 28 due to hoop stresses within the sheared material. The clipped blade 34 remains on the riser 20.

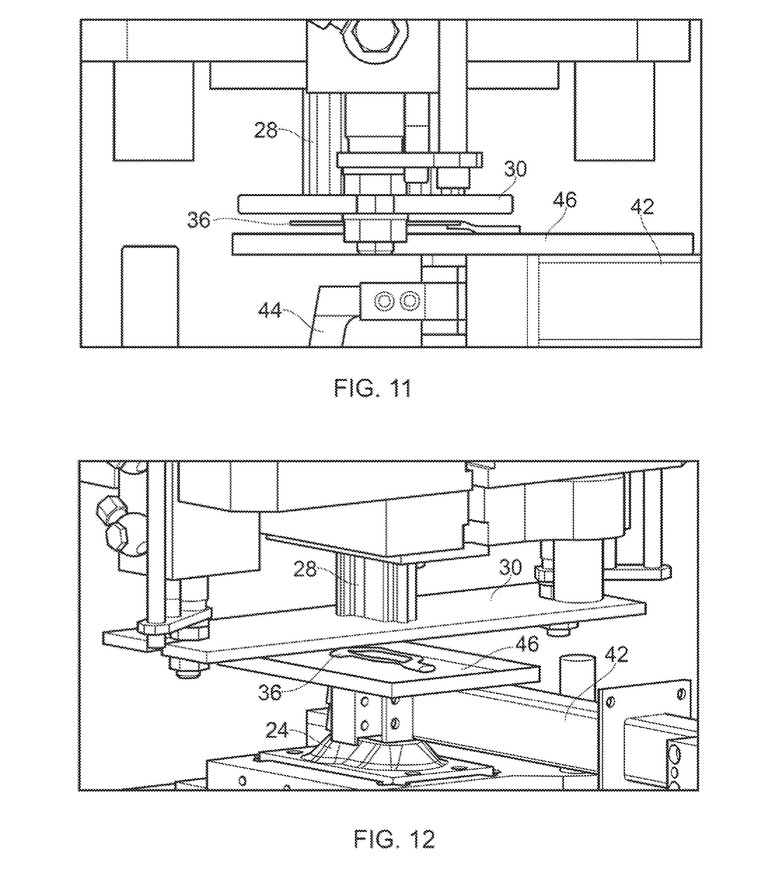

A second robot arm 42 having a gripper 44 for the clipped blade 34 moves into position to remove the blade (FIG. 10 side view). A receptacle in the form of a tray 46 is mounted to the upper side of the arm, the tray being positioned on the arm so that when the gripper holds the blade the tray is interposed between the punch 28 and the riser 20. The robot arm then moves slightly upwards to level the tray and triggers the stripper plate 30, which is hydraulically actuated to slide downwards over the outer surface of the punch, shedding the retained flash 36 onto the tray (FIG. 11 side view).

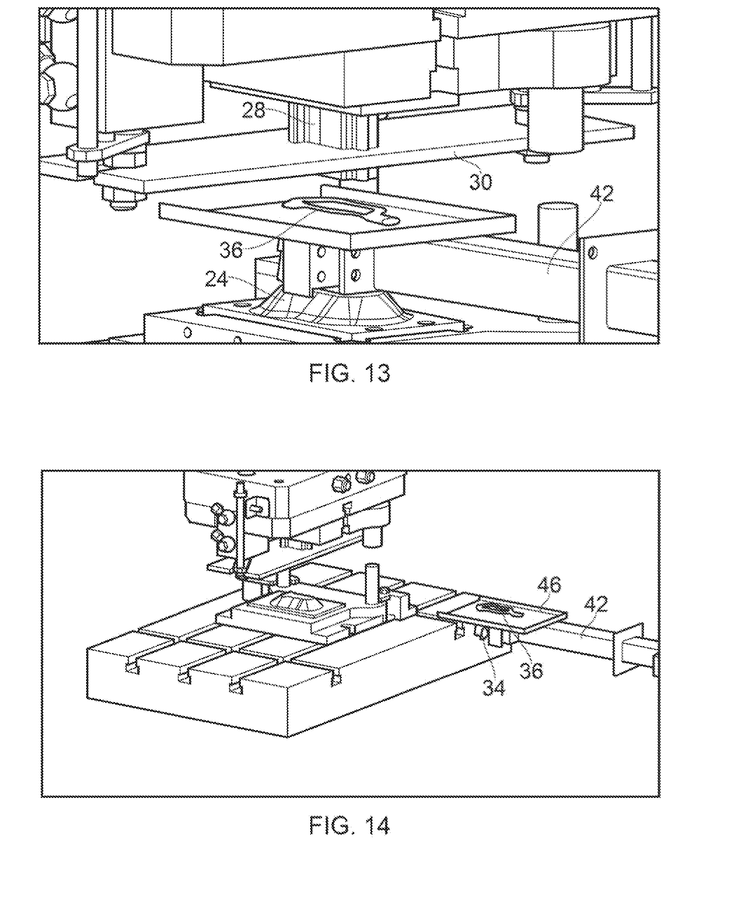

The second robot arm 42 retracts, withdrawing the flash 36 from the clipping area of the tool (FIG. 12 perspective view). The stripper plate 30 slides upwards over the punch to return to its home position and completing the stripping stroke (FIG. 13 perspective view).

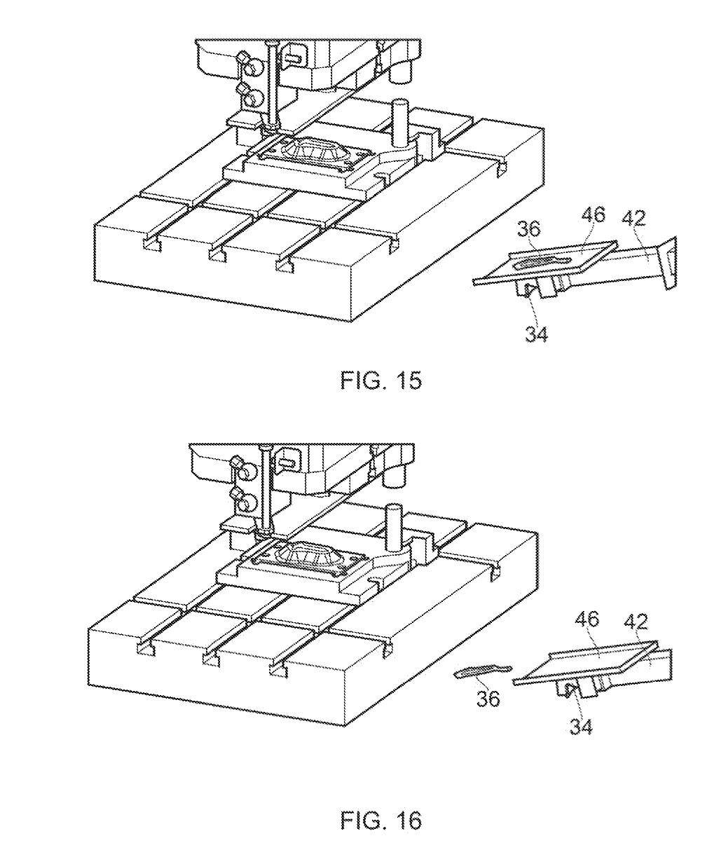

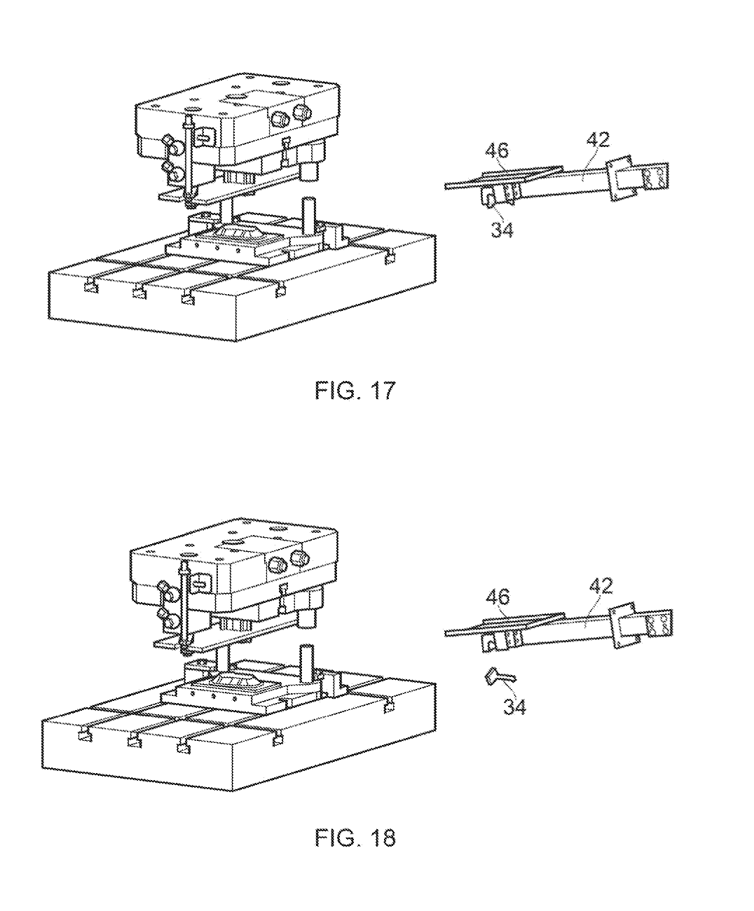

The second robot arm 42 retracts further holding the blade 34 (FIG. 14 perspective view). The arm tilts to deposit the flash 36 into a bin (FIGS. 15 and 16 perspective views), and then transfers the blade onto a heat treatment conveyor (FIGS. 17 and 18 perspective views).

Advantageously, the clipping tool, under the control of a control system, allows the clipping to be carried out separately from but coordinated with the flash stripping action in a fully automated operation. The stripping action sheds the flash onto the tray on the top of the second robot arm, the interposed location of the tray preventing the flash from falling on the riser.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

1. A clipping tool for clipping flash from a forged component, the clipping tool including:
a riser having a support surface for supporting the component;
a punch for gripping the component on the support surface such that the flash projects laterally from the riser and the punch; and
a tool body having an aperture through which the riser and the punch are translatable to shear the projecting flash from the gripped component, the sheared flash being pushed by the tool body over an outer surface of the punch;
wherein the clipping tool further includes:
a controllably movable receptacle which, when the punch is withdrawn from the aperture, is interposed between the punch and the riser; and
a stripper element which is actuatable to strip the sheared flash from the outer surface of the punch, the stripped flash being received by the interposed receptacle, which is then moved to dispose of the stripped flash.

2. A clipping tool according to claim 1, wherein the stripped flash falls by gravity onto the receptacle.

3. A clipping tool according to claim 1 further including a control system which controls and coordinates movement of the receptacle and actuation of the stripper element.

4. A clipping tool according to claim 1, wherein the stripper element is hydraulically actuated.

5. A clipping tool according to claim 1, wherein the stripper element provides a further aperture through which the punch slides to strip the sheared flash from the outer surface of the punch.

6. A clipping tool according to claim 1 further including a robotic arm with a gripper which collects and removes the clipped component from the punch.

7. A clipping tool according to claim 6, wherein the receptacle is mounted on the robotic arm, the receptacle being interposed between the punch and the riser when the gripper collects the clipped component from the punch.

8. A clipping tool according to claim 1, wherein the riser is hydraulically cushioned.

9. A clipping tool according to claim 1, wherein the component is a stator vane or rotor blade of a gas turbine engine.
